(19) United States
(12) Patent Application Publication
(10) Pub. No.: US 2001/0012711 A1
(43) Pub. Date: Aug. 9, 2001

(54) LOW INSERTION FORCE CONNECTOR

(76) Inventors: YASUHIRO SASAKI, SHIZUOKA (JP); HIROSHI YAMAMOTO, SHIZUOKA (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/257,244

(22) Filed: Feb. 25, 1999

(30) Foreign Application Priority Data
Feb. 27, 1998 (JP) 10-047748

(51) Int. Cl. H01R 13/62

(52) U.S. Cl. 439/157

(57) ABSTRACT

A low insertion force connector is provided, which includes: a female connector; a male connector to be coupled with the female connector; and an operation lever rotatably attached to the female connector for facilitating coupling and uncoupling of the male and female connectors, the operation lever having an operation plate with grid-like reinforcing ribs crossing lengthwise and crosswise or diagonally on one of front and back surfaces. Thus, the operation plate is strengthened by the grid-like reinforcing ribs enough to facilitate the coupling and uncoupling of the male and female connectors and simultaneously is capable of indicating an operation state of the operation lever with this structural difference between the front and back surfaces.

### BACKGROUND OF THE INVENTION

1. Field of the Invention

The present invention generally relates to a low insertion force connector (hereinafter “a LIF connector”) having an operation lever for facilitating coupling and uncoupling of male and female connectors with a plurality of electric terminals and more particularly, to a low insertion force connector which has the operation lever with an operation plate improved in strength and simultaneously having a difference in appearance between the front and back surfaces thereof.

2. Description of the Related Art

As a first prior art, FIG. 4 shows a prior art LIF connector disclosed in Japanese Patent Application Laid-open No.5-290921 (hereinafter “JP '921”).

Referring to FIG. 4, a reference numeral 110 indicates a female connector with a housing 111 provided with receiving portions 112A,112B for male connectors 120A,120B.

Each of the receiving portions 112A,112B are provided with horizontal guiding grooves 113,113 on respective side walls, and the housings 111 are projectingly provided with axial shafts 114 on respective side walls.

On the other hand, housings 121A,121B of the male connectors 120A,120B are provided with engaging projections 122, each introduced into the guiding groove 113 of the female connector 110, on respective side walls. Reference numeral 130 is allotted to the operation lever, and the operation lever 130 consists of three (3) side plates 130B,130C,130D each having a circular arc4ike cam-groove 131 and a single operation plate 130A connecting the side plates 130B,130C,130D.

The side plates 130B,130D are provided with respective bearing holes 132 to engage the respective axial shafts 114 so as to rotatably mount the operation lever 130 on the housing 111 of the female connector 110.

Firstly, one end of the cam-groove 131 of the operation lever 130 is positioned at an entrance of the guiding groove 113 of the female connector 110.

In this state, the male connectors 120A,120B are provisionally inserted into the receiving portions 112A,112B of the female connector 110, and the engaging projections 122 of the male connectors 120A,120B are simultaneously introduced into both of the guiding grooves 113 and the cam-grooves 131.

Then, the engaging projections 122 are led to finishing ends of the guiding grooves 113 and of the cam-grooves 131 by turning the operation lever 130 by approximately 90°, and then the receiving portions 112A,112B are introduced into the male connectors 120A,120B and thereby the male connectors 120A,120B are coupled to the female connector 110.

Next, as a second prior art, FIG. 5 shows another prior art LIF connector disclosed in Japanese Patent Application Laid-open No.7-169529 (hereinafter “JP '529”).

The LIF connector consists of a male connector 210 with female terminals (not shown) and a female connector 220 with male terminals (not shown).

The male connector 210 is provided with an operation lever 211 formed integrally with a cam 211a, and the operation lever 211 is rotatably attached to supporting panels 212,212 standing on an upper surface of the male connector 210 through an axis 213. And, two pairs of locking nails 214,214 to lock the operation lever 211 in respective turned states differing each other by 180° stand on the upper surface the male connector 210.

On the other hand, a driven shaft 221 stands on the female connector 220 in the center thereof. The driven shaft 221 is rotatably linked to the cam 211a of the operation lever 211 through a through hole (not shown) in the center of the male connector 210. According to the above-described structure, the male connector 210 and the female connector 220 are coupled or uncoupled with a vertical movement of the driven shaft 221 caused by rotation of the operation lever 211 by 1800.

With respect to the above first prior art LIF connector, however, since the operation plate 130A of the operation lever 130 is in a plate4ike shape with almost the same thickness as of the side plates 130B,130C,130D, the operation plate 130A is very weak and is apt to deform when the male connectors 120A,120B are coupled or uncoupled to the female connector 110, thereby causing a lowering in operability of the operation lever 130.

Also, with respect to the above second prior art LIF connector, since front and back surfaces of the operation lever 211 can not be easily distinguished due to a square bar with flat surfaces, it is difficult at a first glance to judge which state of coupling or uncoupling the operation lever 211 shows, thereby causing a lowering in coupling or uncoupling workability.

Further, with respect to the above first and second prior art LIF connectors, since the operation plate 130A of the operation lever 130 and a holding portion of the operation lever 211 are made of smooth surfaces, they are slippery to be handed, thereby causing a lowering of an operability.

### SUMMARY OF THE INVENTION

In view of the foregoing, an object of the present invention is to provide a LIF connector having an operation lever with an operation plate improved in strength and simultaneously having a difference in appearance between the front and back surfaces thereof, whereby deformation of the operation plate can be prevented, the operation plate can be held without a slip, and an operation state of the operation lever can be grasped at a glance.

In order to achieve the above-described object, as a first aspect of the present invention, a low insertion force connector consists of: a female connector; a male connector to be coupled with said female connector; and an operation lever rotatably attached to said female connector for facilitating coupling and uncoupling of said male and female connectors, said operation lever having an operation plate with a structural difference between front and back surfaces thereof, wherein said operation plate is strengthened by said structural difference enough to facilitate said coupling and uncoupling of said male and female connectors and simultaneously is capable of indicating an operation state of said operation lever with said structural difference.

As a second aspect of the present invention, in the low insertion force connector with the above first aspect, the operation plate is provided with reinforcing ribs on either of the front and back surfaces as the structural difference thereof.

As a third aspect of the present invention, in the low insertion force connector with the above second aspect, the reinforcing ribs are grid4ike nbs crossing lengthwise and crosswise or diagonally.

As a fourth aspect of the present invention, in the low insertion force connector with the above third aspect, the operation lever has a pair of side plates connected with the operation plate and each provided with a cam-groove; the female connector has a receiving portion to receive the male connector, a through hole communicating with the receiving portion, and a pedestal, surrounding one end opening of the through hole, to rotatably support the operation lever; and the male connector has a driven shaft to be put through the through hole of the female connector and a pair of engaging projections provided on the driven shaft to engage the cam-grooves of the operation lever. According to the above-described structure, since strength of the operation plate is improved by the reinforcing rib, deformation of the operation plate can be surely prevented when the operation lever is operated. And, since the reinforcing ribs distinguish the front and back surfaces of the operation plate of the operation lever, an operation state of the operation lever can be grasped at a glance according to a state, namely front or back, of the operation plate. Further, the operation plate can be held without a slip due to the reinforcing nibs. With the above-described effects, operability of the operation lever can be improved and, therefore, workability for coupling and uncoupling of the male and female connectors can be improved.

The above and other objects and features of the present invention will become more apparent from the following description taken in conjunction with the accompanying drawings.

### BRIEF DESCRIPTION OF THE DRAWINGS

FIG. 1 is an exploded perspective view showing an embodiment of a LIF connector in accordance with the present invention;

FIG. 2A is a sectional view showing an operation lever of the LIF connector of FIG. 1;

FIG. 2B is a top view, viewed along an arrow A in FIG. 1, showing the operation lever of FIG. 2A;

FIGS. 3A and 3B are partially sectional views showing coupling movement of male and female connectors of the LIF connector of FIG. 1;

FIG. 4 is an exploded perspective view showing a first prior art LIF connector; and

FIG. 5 is an exploded perspective view showing a second prior art LIF connector.

### DESCRIPTION OF THE PREFERRED EMBODIMENT

An embodiment of the present invention will now be described in further detail with reference to the accompanying drawings.

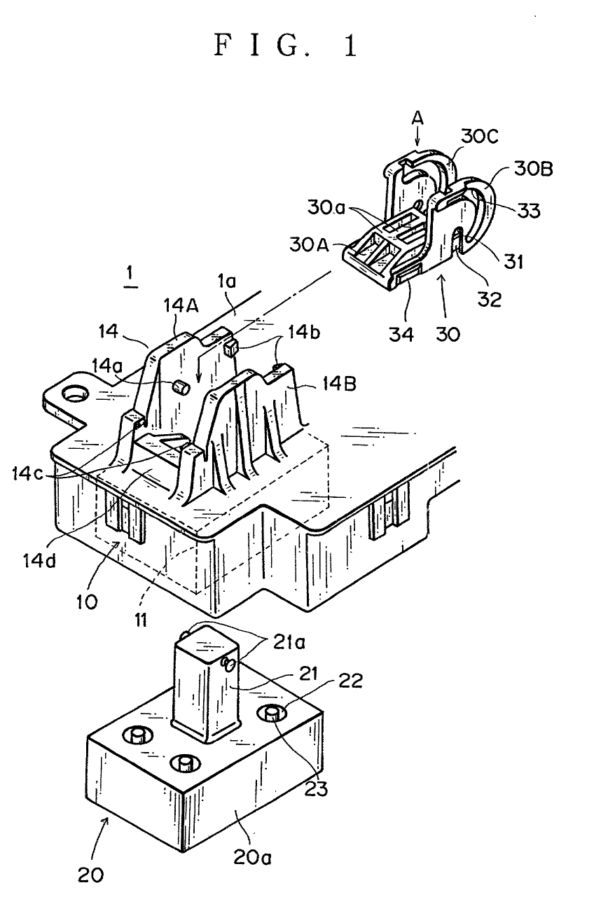

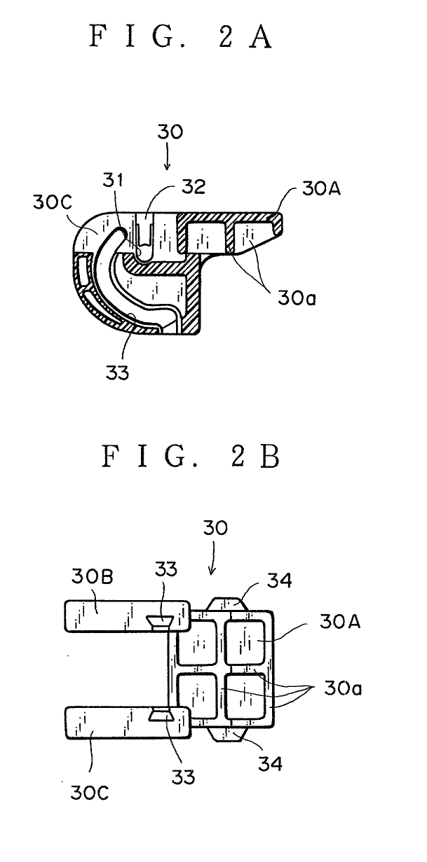

FIG. 1 is an exploded perspective view showing an embodiment of a LIF connector in accordance with the present invention.

An operation lever in FIG. 1 is shown upside down for indicating a reinforcing rib formed on the back of an operation plate.

Referring to FIG. 1, the LIF connector of the present embodiment consists of a female connector 10 formed integrally with a housing 1a of an electric junction box 1, a male connector 20 to be accommodated in a rectangular receiving portion 11 of the female connector 10, and an operation lever 30 attached rotatably on the housing 1a.

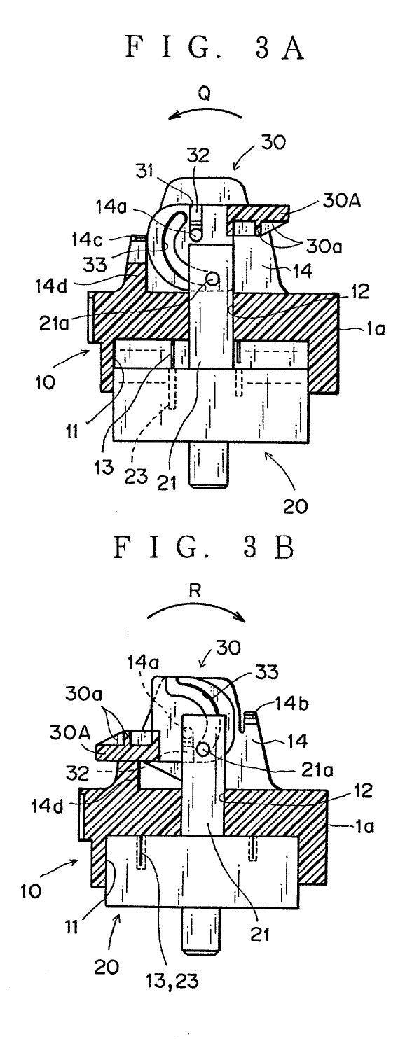

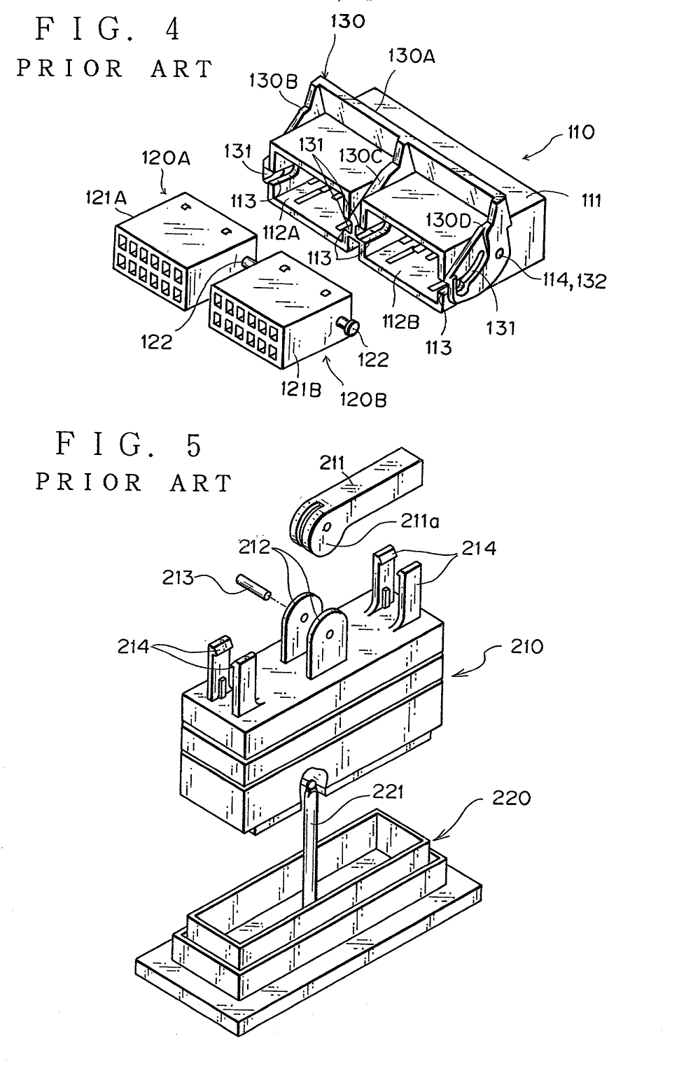

As shown in FIGS. 1, 3A, and 3B, the female connector 10 is provided with the receiving portion 11 to receive the male connector 20 and a rectangular through hole 12 communicating with the receiving portion 11 is formed on the top wall of the housing 1a. The receiving portion 11 is projectingly provided with a plurality of male terminals 13 therein. The male terminals 13 are connected to a busbar (not shown) arranged in the housing 1a.

A pedestal 14 surrounding the through hole 12 is formed integrally with an upper surface of the housing 1a. The pedestal 14 is made up of side walls 14A,14B facing to each other, and axial shaft 14a is formed projectingly in the center of each of the side walls 14A,14B. And, a first locking nail 14b is provided on one side of each of the side walls 14A,14B, and a second locking nail 14c is provided on the other side of each of the side walls 14A,14B. That is, the first locking nail 14b and the second locking nail 14c are located almost symmetrically with the axial shaft 14a.

Further, a stopper 14d connected to both of the side walls 14A,14B is formed under the second locking nails 14c.

The male connector 20 has a housing 20a, with a rectangular cross-section, corresponding to the receiving portion 11 of the female connector 10, and a driven shaft 21, with a rectangular cross-section, corresponding to the through hole 12 of the female connector 10 stands on an upper surface of the housing 20a. The driven shaft 21 is provided with a guided projection 21a on both sides of the top end.

The housing 20a is provided with a plurality of terminal holes 22 on the top thereof, and a plurality of female terminals 23 to be connected to the male terminals 13 of the female connector 10 are accommodated in the terminal holes 22.

Referring to FIG. 1, the operation lever 30 consists of an operation plate 30A in a rectangular shape and a pair of side plates 30B,30C formed integrally with the operation plate 30A on both sides thereof.

As shown in FIGS. 1,2A, and 2B, the operation plate 30A is integrally provided with grid-like reinforcing ribs 30a, crossing lengthwise and crosswise, on the back thereof. The operation plate 30A is a portion to be held by fingers when the operation lever 30 is turned.

The reinforcing ribs 30a strengthen the operation plate 30A and prevent the operation plate 30A from bending.

The side plates 30B,30C each are provided with both of a shaft receiving groove 31 in a straight shape and a cam-groove 33 in a circular arc-like shape.

The shaft receiving groove 31 corresponds to the axial shaft 14a projecting from the pedestal 14 of the female connector 10 shown in FIG. 1 and has a starting end as an entrance to receive the axial shaft 14a and a semicircular finishing end with almost the same diameter as the axial shaft 14a.

The shaft receiving groove 31 is integrally provided with a resilient locking portion 32 on the entrance side. The edged end of the locking portion 32 abuts on a periphery of the axial shaft 14a so as to hold the axial shaft 14a on the side of the finishing end of the shaft receiving groove 31, thereby rotatably attaching the operation lever 30 on the pedestal 14 of the female connector 10.

On the other hand, the cam-groove 33 corresponds to the guided projection 21a projecting from the driven shaft 21 of the male connector 20 shown in FIG. 1 and has a starting end as an entrance to receive the guided projection 21a and a semicircular finishing end with almost the same diameter as the guided projection 21a.

Projecting strips 34 are provided outwardly on both sides of the operation plate 30A.

The projecting strips 34 engage the first locking nails 14b of the pedestal 14 when the operation lever 30 has been turned in an arrow R direction from a state of FIG. 3B to another state of FIG. 3A, and, on the contrary, engage the first locking nails 14c of the pedestal 14 when the operation lever 30 has been turned in an arrow Q direction from the state of FIG. 3A to the state of FIG. 3B.

Uncoupling operation of the male and female connectors of the LIF connector with the above-escribed structure will be described hereinafter with reference to FIGS. 1,3A, and 3B.

In case of coupling the male connector 20 to the female connector 10, to begin with, the projecting strips 34 are engaged with the first locking nails 14b as shown in FIG. 3A by rotating the operation lever 30, whereby the operation lever 30 is fixed to the pedestal 14 and the entrance of the cam-groove 33 of the operation lever 30 is positioned on the through hole 12 of the female connector 10.

Next, the male connector 20 is provisionally inserted in the receiving portion 11 of the female connector 10, wherein the driven shaft 21 of the male connector 20 projects from the through hole 12 of the female connector 10 and the engaging projections 21a each are set at the respective entrances of the cam-grooves 33.

From this state, by turning the operation lever 30 in the arrow Q direction with use of the operation plate 30A, the projecting strips 34 are disengaged from the first locking nails 14b, the engaging projections 21a move along the cam-grooves 33, and then the male connector 20 is drawn into the receiving portion 11 of the female connector 10.

Finally, as shown in FIG. 3B, the engaging projections 21a reach the finishing ends of the cam-grooves 33, that is, the male connector 20 is completely inserted in the receiving portion 11, whereby the male connector 20 is completely coupled to the female connector 10. In this state, the male terminals 13 in the female connector 10 are connected to the female terminals 23 in the male connector 20.

Simultaneously with the above state, the operation plate 30A of the operation lever 30 abuts on the stopper 14d of the pedestal 14, while the projecting strips 34 engage the second locking nails 14c, and then the operation lever 30 is fixed to the pedestal 14.

Thus, the male connector 20 and the female connector 10 are kept in a coupled state.

On the other hand, in case of uncoupling the male connector 20 from the female connector 10, reversely to the above process, the operation lever 30 is turned in the arrow R direction shown in FIG. 3B with use of the operation plate 30A, reversely to the above process, and both of the connectors 10,20 are to be in the state of FIG. 3A Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A low insertion force connector comprising:
a female connector;
a male connector to be coupled with said female connector; and
an operation lever rotatably attached to said female connector for facilitating coupling and uncoupling of said male and female connectors, said operation lever having an operation plate with a structural difference between front and back surfaces thereof,
wherein said operation plate is strengthened by said structural difference enough to facilitate said coupling and uncoupling of said male and female connectors and simultaneously is capable of indicating an operation state of said operation lever with said structural difference.

2. The low insertion force connector according to claim 1, wherein
said operation plate is provided with reinforcing ribs on either of said front and back surfaces as said structural difference thereof.

3. The low insertion force connector according to claim 2, wherein
said reinforcing ribs are grid-like ribs crossing lengthwise and crosswise or diagonally.

4. The low insertion force connector according to claim 1, wherein
said operation lever has a pair of side plates connected with said operation plate and each provided with a cam-groove,
said female connector has a receiving portion to receive said male connector, a through hole communicating with said receiving portion, and a pedestal, surrounding one end opening of said through hole, to rotatably support said operation lever, and
said male connector has a driven shaft to be put through said through hole of said female connector and a pair of engaging projections provided on said driven shaft to engage said cam-grooves of said operation lever.

5. The low insertion force connector according to claim 2, wherein
said operation lever has a pair of side plates connected with said operation plate and each provided with a cam-groove,
said female connector has a receiving portion to receive said male connector, a through hole communicating with said receiving portion, and a pedestal, surrounding one end opening of said through hole, to rotatably support said operation lever, and
said male connector has a driven shaft to be put through said through hole of said female connector and a pair of engaging projections provided on said driven shaft to engage said cam-grooves of said operation lever.

6. The low insertion force connector according to claim 3, wherein
said operation lever has a pair of side plates connected with said operation plate and each provided with a cam-groove,
said female connector has a receiving portion to receive said male connector, a through hole communicating with said receiving portion, and a pedestal, surrounding one end opening of said through hole, to rotatably support said operation lever, and
said male connector has a driven shaft to be put through said through hole of said female connector and a pair of engaging projections provided on said driven shaft to engage said cam-grooves of said operation lever.
